(19) United States
(12) Patent Application Publication
(10) Pub. No.: US 2006/0156531 A1
(43) Pub. Date: Jul. 20, 2006

(54) Pipe aligning device and method of use thereof

(76) Inventor: Mark D. Dwileski JR., East Greenbush, NY (US)

Correspondence Address: SCHMEISER, OLSEN & WATTS, 22 CENTURY HILL DRIVE, SUITE 302, LATHAM, NY, 12110, US

(21) Appl. No.: 11/036,848

(22) Filed: Jan. 14, 2005

(51) Int. Cl. B23Q 3/00

(52) U.S. Cl. 29/464

(57) ABSTRACT

A device and method of use for aligning elements is presented. In particular, the present invention relates to the device having particular features and the method for its use for axially aligning and welding elements together, especially pipe elements. Disclosed is a device for aligning the pipe elements which includes a head for surrounding the elements, a plurality of alignment elements for axially aligning the pipe elements, and a pressure mechanism for applying a selectable pressure to the pipe elements. Also disclosed is a device for receiving pipe elements which includes a reversibly attachable alignment head for surrounding the pipe elements, a plurality of multi-axis alignment elements, and a pressure mechanism for applying a selectable pressure to the pipe elements.

### BACKGROUND OF THE INVENTION

1. Field of Invention

The present invention relates to a device and method of use thereof for the alignment of pipes, fittings, and the like. In particular, the present invention relates to the device having particular features, and the method for its use, for aligning pipes and pipe elements so as to easily provide tack welds prior to welding.

2. Related Art

In the field of welding, efforts toward devices and methods to assist in aligning pipes and pipe elements are continuously being made. Devices and methods have been developed to facilitate pipe alignment and subsequent welding. However, existing devices and methods are often bulky, user unfriendly, not capable of use with varying size pipes, inaccurate, imprecise, and time and labor intensive.

Therefore a need exists for a device and method of use for the alignment of pipes and pipe elements which overcomes at least one of the aforementioned deficiencies and others that provides a device and method for efficient, adjustable, easy, accurate, and precise alignment of pipes and pipe elements.

### SUMMARY OF THE INVENTION

One aspect of the present invention an aligning device comprising: a head configured to receive a first element and a second element; and at least one alignment element wherein said alignment element axially aligns said first element with said second element.

A second aspect of the present invention is An aligning device comprising: a handle; a head configured to receive a first element and a second element, wherein said head is configured to be removably attachable to a handle; and at least one alignment element wherein said alignment element axially aligns said first element with said second element.

A third aspect of the present invention is an aligning device comprising: a head configured to receive a first element and a second element, wherein said head is configured to be removably attachable to a handle.

A fourth aspect of the present invention is an aligning device comprising: an alignment element removably attachable to an alignment head, wherein said alignment head is configured to receive a first element and a second element.

A fifth aspect of the present invention is an aligning method comprising: providing a first element and a second element; providing a head configured to receive said first element and said second element, wherein said head includes a least one alignment element further wherein said alignment element is for axially aligning said first element with said second element; and axially aligning said first element with said second element.

A sixth aspect of the present invention is An aligning method comprising: providing a first element and a second element; providing a head configured to receive said first element and said second element; attaching to said head a plurality of tack weld gap elements configured to set a tack weld gap between said first element and said second element; and setting said tack weld gap between said first element and said second element.

A seventh aspect of the present invention is An aligning method comprising: providing a first element and a second element; providing a removably attachable alignment element configured to fit an alignment head, wherein said alignment head is configured to receive and fit said first element and said second element; and axially aligning said first element with said second element.

### BRIEF DESCRIPTION OF THE DRAWINGS

The features of the present invention will best be understood from a detailed description of the invention and an embodiment thereof selected for the purpose of illustration and shown in the accompanying drawing in which:

FIG. 1 depicts a perspective view of an embodiment of an aligning device, in accordance with the present invention;

FIG. 2A depicts a side sectional view of an embodiment the aligning device, in a closed configuration, in accordance with the present invention;

FIG. 2B depicts a side sectional view of an embodiment of the aligning device, in an open configuration, in accordance with the present invention;

FIG. 3 depicts a top view of an embodiment of a portion of the aligning device, in accordance with the present invention;

FIG. 4A depicts a perspective view of an embodiment of an alignment element of the device, in accordance with present invention;

FIG. 4B depicts a side perspective view of an embodiment of the alignment element of the device of FIG. 4A, in accordance with the present invention;

FIG. 4C depicts a perspective view of a second embodiment of an alignment element of the device, in accordance with the present invention;

FIG. 4D depicts a side perspective view of the second embodiment of the alignment element of the device, in accordance with the present invention;

FIG. 4E depicts a perspective view of a third embodiment of the alignment element of the device, in accordance with the present invention;

FIG. 4F depicts a side perspective view of the third embodiment of the alignment element of the device, in accordance with the present invention; and

FIG. 5 depicts a perspective view of an embodiment of a tack weld gap shim, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc. . . . , and are disclosed simply as an example of an embodiment. The features and advantages of the present invention are illustrated in detail in the accompanying drawing, wherein like reference numeral refer to like elements throughout the drawings. Although the drawings are intended to illustrate the present invention, the drawings are not necessarily drawn to scale.

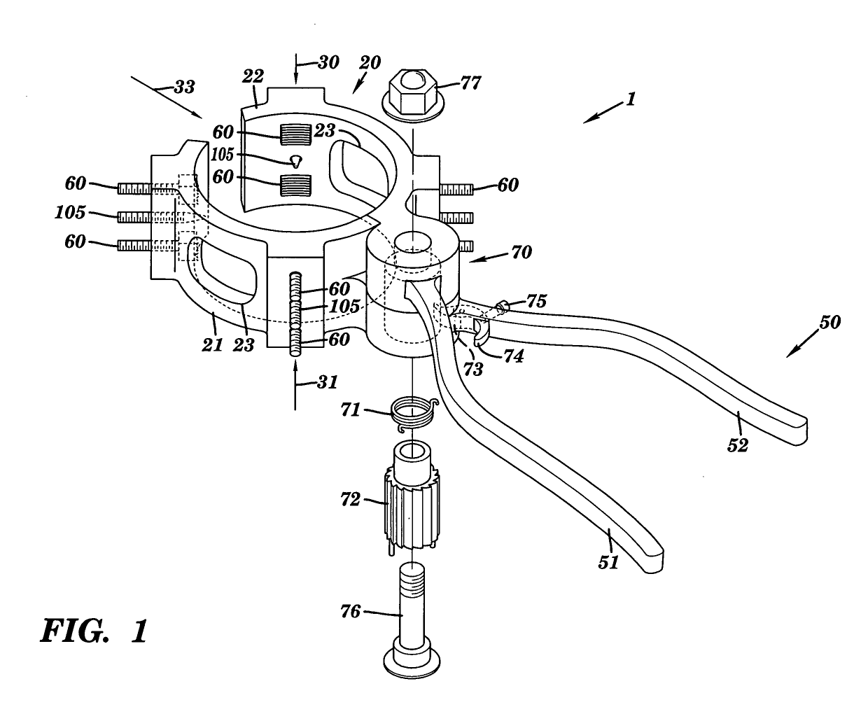

FIG. 1 depicts a perspective view of the device 1 for aligning pipe elements, in accordance with the present invention. The device 1 comprises: an alignment head 20, alignment elements 60, a pressure mechanism 70, a handle 50, and a tack weld shim 105.

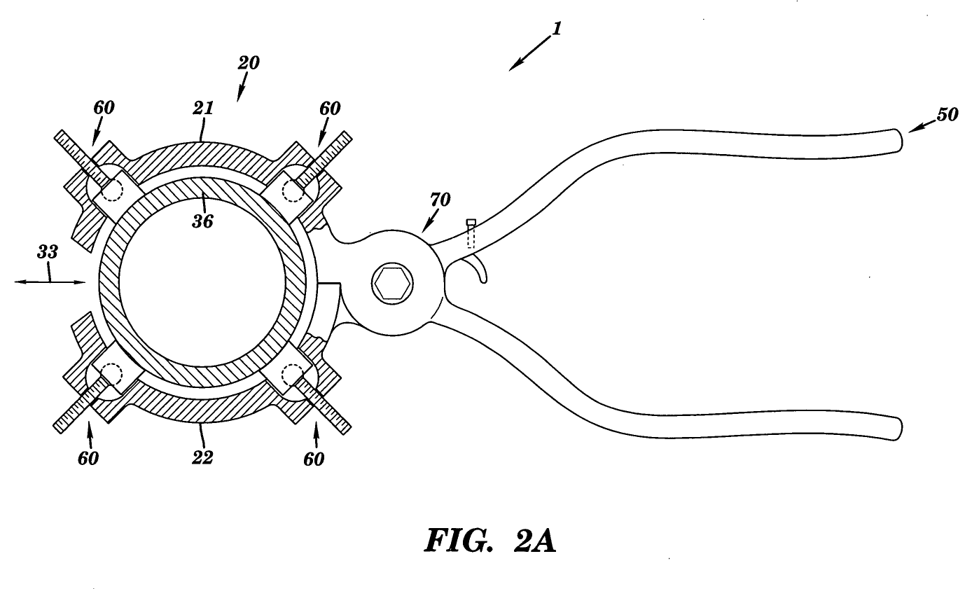

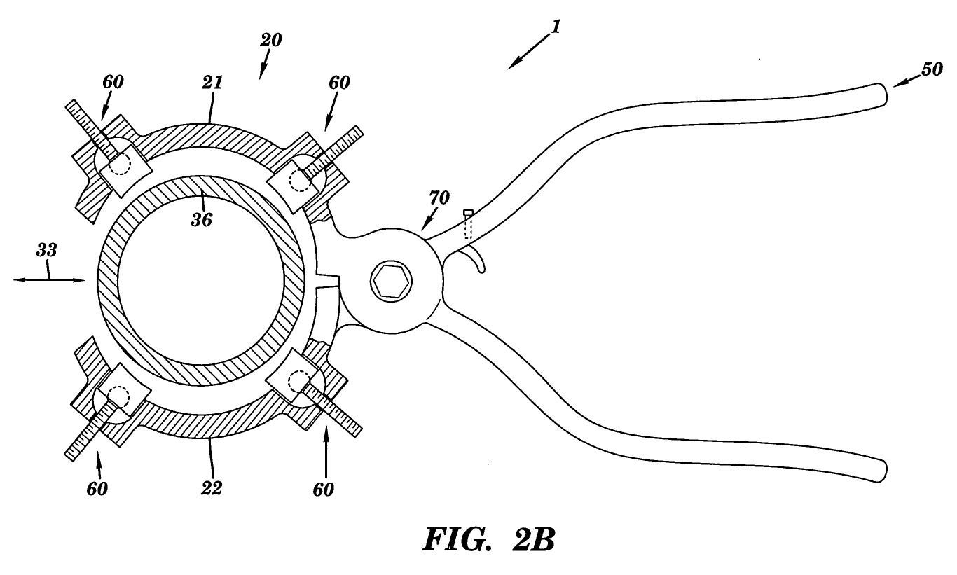

FIG. 2A depicts a side view of the device 1, in a closed configuration, for aligning elements, in accordance with the present invention.

FIG. 2B depicts a side view of the device 1, in an open configuration, for aligning elements, in accordance with the present invention.

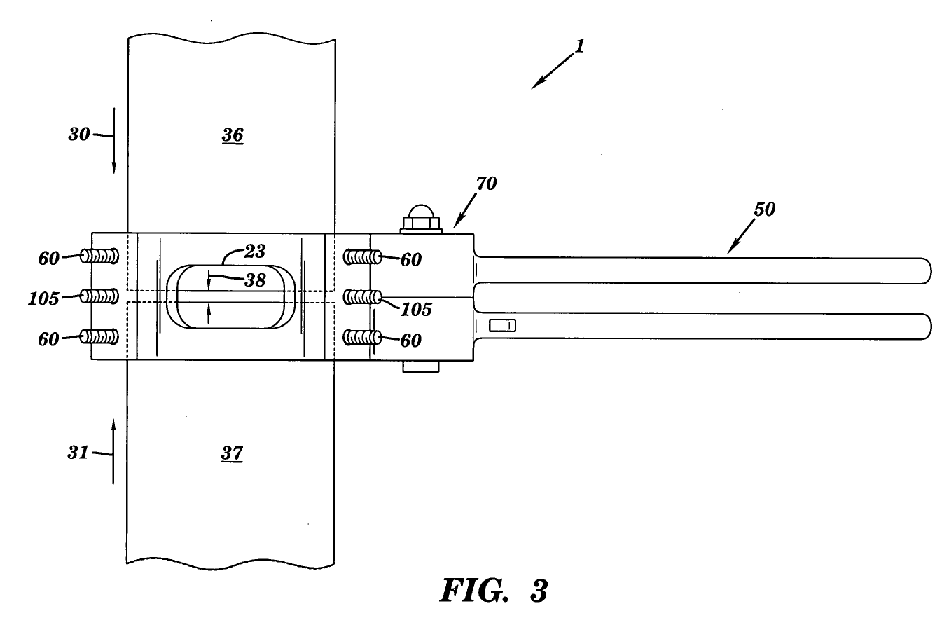

FIG. 3 depicts a top view of the device 1 in use for aligning elements, in accordance with the present invention. Referring to FIGS. 1-3, the alignment head 20 further comprises: an upper jaw 21, a lower jaw 22, and work windows 23.

The jaws 21 and 22 are for holding a first element 36 and a second element 37 so as to allow the elements 36 and 37 to be tack welded together. This is accomplished via the jaws 21 and 22 surrounding the elements 36 and 37. Surrounding as used herein is defined as extending or partially extending on all sides of the first element 36 and the second element 37 simultaneously, i.e., encircle; enclosing or confining, or partially enclosing or partially confining on all sides so as to secure the elements 36 and 37 within the jaws 21 and 22; encompassing or partially encompassing the first element 36 and the second element 37; and combinations thereof.

The jaws 21 and 22 are typically constructed of materials including but not limited to steel, aluminum, iron, ceramic composites, polymer composites, nano-polymer composites, alloys of the aforementioned, and combinations thereof. The construction materials, as previously described, to form the jaws 21 and 22 are not meant to limit the scope of the materials that may be used in an embodiment of the present invention. Any tack weld resistant material as well as weld resistant material having physical and chemical properties to withstand temperatures and pressures typically generated under the aforementioned conditions can be used thereof in accordance with the device and method of the present invention.

Tack welding is the fastening or joining of two elements, via at least one tack weld, by applying heat, sometimes with pressure and sometimes with an intermediate or filler metal having a high melting point. A tack weld is a small scale weld, generally performed in a sequence, of two elements. A sequence of tack welds is used to hold, align, or steer segments of elements to be joined. Elements are defined as elbows, 90° elbows, 45° elbows, tees, reducers, flanges, straight pipe, tubing, hand-railing, boiler tube, square tube, bars, structural shapes, and combinations thereof.

Elements are typically constructed of materials including but not limited to steel, aluminum, copper, brass, iron, ceramic composites, polymer composites, nano-polymer composites, alloys of the aforementioned, and combinations thereof. The composition of the elements, as previously described, is not meant to limit the scope of the types of elements that may be used in an embodiment of the present invention. Any element composition having physical and chemical properties to withstand temperatures and pressures typically generated under welding and tack welding conditions can be used thereof in accordance with the device and method of the present invention.

In the open configuration (see FIG. 2B), the first element 36 may be inserted into the jaws 21 and 22 of the alignment head 20 along a directional arrow 30. The second element 37 then may be inserted into the jaws 21 and 22 along a directional arrow 31. Alternatively, the elements 36 and 37 may be inserted into the jaws along a directional arrow 33. Furthermore, the elements 36 and 37 may be inserted into the jaws 21 and 22 by any combination of the aforementioned methods.

In the closed configuration (see FIG. 1 & FIG. 2A), the upper jaw 21 and the lower jaw 22 typically do not meet together, i.e. do not fully surround the elements 36 and 37. However, the aforementioned configuration as previously described, is not meant to limit the configuration of the jaws 21 and 22 with the elements 36 and 37. The jaws 21 and 22 may fully surround the elements 36 and 37 as previously defined. The closed configuration is characterized by the jaws 21 and 22 locking the elements 36 and 37 within the jaws 21 and 22.

The work windows 23 have multiple uses. The windows 23 allow a user to visually align the elements 36 and 37 after they have been inserted into the jaws 21 and 22. The alignment of the elements 36 and 37 typically is performed with the device 1 in the closed configuration. The alignment of the elements 36 and 37 to each other will be locked in place whilst in the closed position. The windows 23 also allow the user to view the setting of a tack weld gap 38 between the elements 36 and 37. After aligning the first element 36 and second element 37 to user required specifications, the elements 36 and 37 can be tack welded together via welding through the work windows 23. The tack welding can be performed using any of the work windows 23. Typically, the alignment head 20 is comprised of one to four work windows.

The work windows 23 provide a visual confirmation that a chosen or specific tack weld gap 38 clearance between the elements 36 and 37 has been achieved, and also allows the user to quantitatively, i.e., measure the tack weld gap 38 and axial alignment using typical weld gap 38 and axial alignment measuring devices. The work windows 23 also allow the user to inscribe or mark into the elements 36 and 37, in the vicinity of the tack weld, any specifications of the tack weld or information that a user m ay wish to convey about the tack weld.

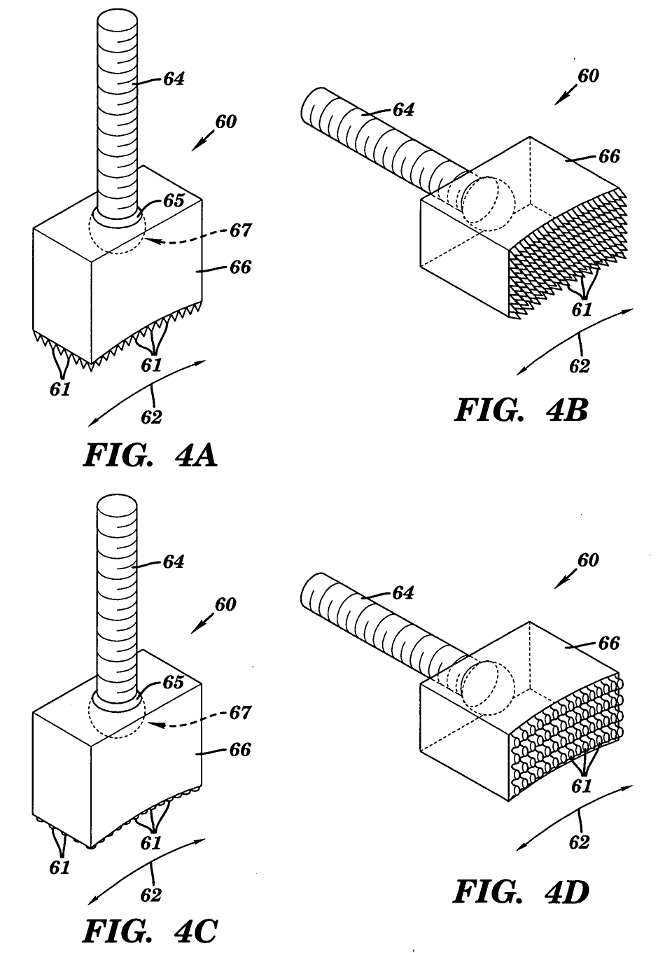

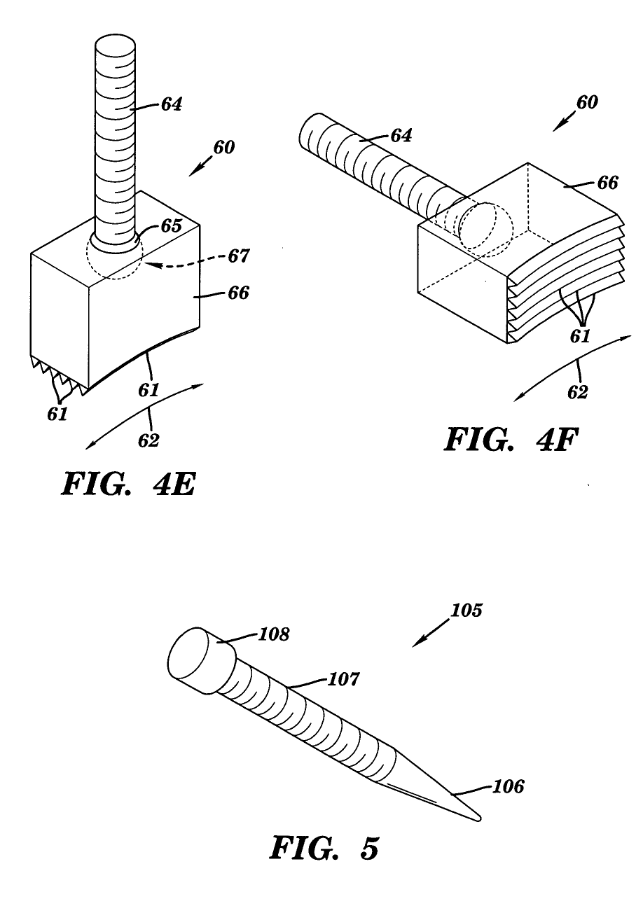

FIG. 4A is a perspective view of an alignment element 60 of the device 1, in accordance with present invention.

FIG. 4B is a side perspective view of the alignment element 60 of the device 1, in accordance with the present invention.

FIG. 4C is a perspective view of a second embodiment of the alignment element 60 of the device 1, in accordance with the present invention.

FIG. 4D is a side perspective view of a second embodiment of the alignment element 60 of the device 1, in accordance with the present invention.

FIG. 4E is a perspective view of a third embodiment of the alignment element 60 of the device 1, in accordance with the present invention.

FIG. 4F is a side perspective view of the third embodiment of the alignment element 60 of the device 1, in accordance with the present invention. Referring to FIGS. 1-4F; the alignment element 60 comprise an alignment element rod 64, a ball and socket joint 65, an alignment element body 66, an alignment element contact area 61, and a ball 67. The alignment element 60 is used to precisely and accurately axially align the elements 36 and 37 within the alignment head 20.

The alignment element body 66 is a shoe, pad, a physical body, device, and the like used to secure the first element 36 and the second element 37 within the alignment head 20. The alignment element contact area 61 is a distinguishable extent of the surface of the alignment element 60 which makes contact with the elements 36 and 37, and secures the elements 36 and 37 within the jaws 21 and 22. The area 61 may be a surface comprising of teeth, pads, irregular projections, regular projections, grooved recesses, micro-teeth, micro-pads, micro-projections, and the like. The area 61 further may have coatings of the aforementioned on the area 61. The contact area 61 is generally arcuate shaped, as indicated by arrow 62.

The alignment element rod 64 is used to control movement of the alignment element body 66. The element rod 64 is operably connected to the ball 67 which fits into the ball and socket joint 65 of the element body 66. Adjustment of the element rod 64 in one direction, for example turning of the element rod 64 clockwise, results in the element body 66 moving towards the elements 36 and/or 37. As the element rod 64 is further adjusted, the element body 66 eventually will contact the elements 36 and/or 37 resulting in the axial movement of the elements 36 and/or 37.

Adjustment of the element rod 64 in the opposite direction, for example turning of the element rod 64 counter-clockwise, results in the element body 66 moving away from the elements 36 and/or 37. As the element rod 64 is further adjusted, the element body 66 eventually will lose contact with the elements 36 and/or 37. The alignment body 66 has a range of movement from about +¼ inch to about −¼ of an inch.

Typically, the alignment elements 60 are evenly spaced around the alignment head 20 thus allowing for adjustment of the elements 36 and 37 in two axis. Adjustment of the elements 36 and 37 along the third axis is performed by hand. The device 1, via the alignment elements 60, is able to axially aligning the elements 36 and 37 in along three different axis.

The connection with the ball 67 of the alignment element rod 64 and, the ball and socket joint 65 may be permanent, i.e. an integral attachment, or removably attachable with the joint 65 thus allowing varying size alignment elements 60 to be used with the device 1. Furthermore, the alignment element 60 may be integrally attached to the alignment head 20 or it may be non-integrally attached to the alignment head via a wing nut, a square nut, flanges, clips, and the like.

The alignment element 60 is constructed of materials including but not limited to steel, aluminum, iron, copper, brass, ceramic composites, polymer composites, nano-polymer composites, alloys of the aforementioned, and combinations thereof. The construction materials, as previously described, to form the element 60 are not meant to limit the scope of the materials that may be used in an embodiment of the present invention. Any tack weld resistant material having physical and chemical properties to withstand temperatures and pressures typically generated under tack welding conditions can be used to form the alignment element 60 thereof in accordance with the device and method of the present invention.

Referring to FIGS. 1-3, a pressure mechanism 70 of the device 1, in accordance with the present invention, may comprise: a torsion spring 71, a ratchet 72, a pawl 73, a trigger release 74, a tension control pin 75, a bolt 76, and a nut 77. The pressure mechanism 70 allows the user to provide a selectable pressure to the jaws 21, 22 and the pipe elements 36 and 37 held therein. Typically the pressure selected lies in a range from about 0 Pounds per Square Inch (PSI) to about 2,500 PSI. Further, the design is such that the pressure mechanism 70 can readily be released so as to remove all pressure from the pipe elements and/or to adjust the pressure applied to a different (i.e., greater or less) pressure.

The mechanism 70 includes a torsion spring mechanism which consists of a torsion spring 71 for creating tension to the pawl 73 that engages the teeth of the ratchet 72, permitting motion in one direction with a quick release for motion in the opposite direction. Furthermore, the mechanism 70 allows for pressure to be created and directed outwardly to the user's hand via the handles 51 and 52. This provides for a greater feel for and ease in handling the device 1 during axial alignment of the elements 37 and 37 as well as during tack welding.

The pressure mechanism 70, as previously described, is not meant to limit the scope of pressure mechanism that may be used in an embodiment of the present invention. Alternative examples of pressure mechanisms that can be use thereof include but are not limited to any type of pawl and ratchet mechanism, and the like. Any pressure mechanism that can produce pressures used to align and secure pipe elements during tack welding conditions can be used thereof in accordance with the device and method of the present invention.

Referring to FIGS. 1, 2A, and 2B the handle 50 comprises: an upper arm 51 and a lower arm 52. The upper arm 51 is connected to the lower jaw 22 and the lower arm 52 is connected to the upper jaw 21. The arms 51 and 52 are so designed such as to allow a user to hold the device 1 with one hand and to selectively apply pressure, via the pressure mechanism 70, while manipulating the elements 36 and 37 with the other hand as well as performing tack welding and related tasks to the elements 36 and 37. Typically the handle 50 is from about 6 inches to about 9 inches in length. This distance may or may not include the pressure mechanism 70 in the final measurement.

Typically, the alignment head 20, the pressure mechanism 70, and the handle 50 of the device 1 are configured as one piece and not removably attachable from one another. The aforementioned configuration, as previously described, is not meant to limit the scope of the present invention. Alternatively, it can be envisioned where the alignment heads are of differing sizes such as ¼″, ½″, ¾″, 1″, 1¼″. . . up to 8″ outer diameter (O.D.) may be reversibly attachable from the handle 50 and/or the pressure mechanism 70. The characteristic of having an alignment head 20 that is reversibly attachable allows for the use of the one handle 50 and one pressure mechanism 70 with a wide variety of different sized alignment heads for aligning and tack welding elements 36 and 37 of varying sizes.

Typically, an area on the pressure mechanism 70 between the mechanism 70 and the jaws 21 and 22 exists where the alignment head 20 is removably attached to or from the mechanism 70. The means of removable attachment include but are not limited to a hinge, a snap-fit bolt and lock, a screw-in bolt and lock, a sliding bolt and lock, and combinations thereof.

Alternatively, the area for removable attachment of the alignment head 20 may exist between the pressure mechanism 70 and the handle 50. The pressure mechanism 70 is may be integrally attached to the alignment head 20. Thus, the alignment head 20 having the pressure mechanism 70 integrally attached to the head 20 can be removably attached to the handle 50. The means of removable attachment include but are not limited to a hinge, a snap-fit bolt and lock, a screw-in bolt and lock, a sliding bolt and lock, and combinations thereof.

FIG. 5 is a perspective view of the tack weld shim 105 of the device 1, in accordance with the present invention. Referring to FIGS. 1, 3 and 5, the tack weld shim 105 comprises: a shim end 106, a shaft 107, and an adjustment head 108. The tack shim 105 is used to set the tack weld gap 38 between elements. The adjustment head 108 is used to lower or to raise the entire tack shim 105. Typically this is accomplished via turning of the head 108 clockwise or counter-clockwise causing movement of the tack shim 105 toward or away from the tack shim 105. Alternatively, the head 108 may be pushed or pulled to cause movement of the tack shim 105. The methods of adjusting the tack shim 105, as previously described, are not meant to limit the scope of the methods that may be used in an embodiment of the present invention. Any method or device that allows for controlled movement of the tack shim 105 required under tack welding conditions or pre-tack weld conditions can be used thereof in accordance with the device and method of the present invention.

The shaft 107 extends through the alignment head 20 and typically is threaded to allow a twisting or rotating motion as described above. Alternatively though, the shaft may be configured in any way such as to allow movement of the shim 105 within the alignment head 20 and within the tack weld gap 38. For example, the shaft 107 may be notched, graduated, demarcated, and the like to allow controlled movement of the shim 105 into the tack weld gap 38.

The shim end 106 is the portion of the tack shim 105 that extends into the tack weld gap 38. The end 106 is typically tapered to allow easy removal of the shim 105 from the weld gap 38 after tack welding has be performed. The end 106 also may be coated with materials including but not limited to ceramics, nano-composites, polymer composites, nano-polymer composites, alloys of the aforementioned, and combinations thereof to further enhance the ease of removal of the tack shim 105 from the weld gap 38 after tack welding has been performed.

The end 106 typically is conical in shape but may be cylindrical, trapezoidal, frustro-conical, and combinations thereof. Any shape of the end 106 that can provide and maintain a pre-selected tack weld gap 38 between elements under tack welding conditions or pre-tack weld conditions used as well as allowing for ease of removal from the tack weld gap 38 after tack welding can be used thereof in accordance with the device and method of the present invention.

Referring to FIGS. 1-5, in use of the device 1 in accordance with the present invention, a user adjusts the device 1 having an integrated alignment head 20 to an open configuration (see FIG. 2B) by releasing the pressure mechanism 70. In this example the pressure mechanism 70 is a torsion spring mechanism, and the elements 36 and 37 are straight pipes and shall be referred herein as pipes 36 and 37. The jaws 21 and 22 are opened to provide a clearance wide enough for the pipes 36 and 37 to be inserted or slipped into the jaws 21 and 22 along the directional arrows 30 and 31 respectively or along the directional arrow 33. Anytime during the insertion step, the alignment elements 60 can be adjusted, using the alignment element rod 64, also to allow maximum clearance for insertion of the straight pipes 36 and 37.

The pipes 36 and 37 then are inserted until the edges of the pipes 36 and 37 are in the vicinity of each other and can be viewed in the tack weld window 33. Pressure is applied to the pipes 36 and 37 via the pressure mechanism 70 to loosely secure the pipes 36 and 37.within the jaws 21 and 22, and more specifically via the alignment element bodies 66 of the alignment elements 60. The alignment element rods 64 are then adjusted to further apply pressure to the pipes 36 and 37; to secure the pipes 36 and 37 within the alignment head 20; and to axially align the pipes 36 and 37.

The method of applying pressure, securing, and axially aligning the straight pipes 36 and 37 is an iterative one. The method is repeated as many times as necessary to accurately and precisely align the pipes 36 and 37 with each other for tack welding and other welding tasks. Furthermore, applying pressure, securing, and axially aligning the pipes 36 and 37 can be done in any order or in any combination. For example, a user can first secure the pipes 36 and 37 using the alignment elements 60 before using the pressure mechanism 70 to lock the pipe elements 36 and 37 in place.

Having accurately and precisely aligned the straight pipes 36 and 37, the tack weld gap 38 typically then is set using the tack weld gap shim 105. The tack weld shim end 106 of the tack shim 105 is inserted between the straight pipes 36 and 37 via the adjustment head 108. In this example, the tack shim 106 comprises a threaded shaft 107 and a conical end 106 that is demarcated. The head 108 is turned or rotated in a clockwise direction causing the shim 105 and more specifically the conical end 106 to move towards/into the tack weld gap 38. In this example, each demarcation is equivalent to 4 mm of space between the pipe elements 36 and 37. Inserting the end 106 of the tack shim 105 to the 4^{th} demarcation is equivalent to setting the tack weld gap 38 to 16 mm.

Alternatively, each demarcation could be equivalent to 1 mm, 2 mm, 3 mm or any unit of distance typically used for tack weld gaps 38 and tack welding conditions. The tack weld gap 38 can be set from about ⅛ inch to about ⅕ inch. After having set the tack weld gap 38, the user then may tack weld the pipe elements 36 and 37 knowing that the straight pipes 36 and 37 have been accurately and precisely aligned and the tack weld gap 38 set per the user's requirement. The device 1 containing the pipes 36 and 37, axially aligned and having a chosen tack weld gap 38, is held in one hand while the other hand is used to hold and operate a welding torch for subsequent tack welding.

After tack welding is completed, the user removes the tack weld shims 105 from the tack weld gap 38. The configuration of the shim end 106 is conducive for easy removal. The pipes 36 and 37 exert significant pressure on the shim end 106 due to cooling of the tack weld and a resultant contraction of the tack weld. The conical shape of the shim end 106 allows the user to easily remove the tack weld shim 105 from the shim gap 38. Any tack weld shim 105 having concial, cylindrical, trapezoidal, frustro-conical, and combinations thereof or having coatings with materials including but not limited to ceramics, nano-composites, polymer composites, nano-polymer composites, alloys of the aforementioned can be used thereof in accordance with the device and method of the present invention.

Typically, a user may axially align and tack weld elements having a particular diameter with the alignment device 1 appropriately sized to work with the aforementioned pipes. Alternatively, a user may axially align and tack weld elements using an aligning device having a non-integrally attached alignment head, i.e., a reversibly attachable head for surrounding, securing, and axially aligning the elements.

In use of an aligning device having a reversibly attachable head, a user assembles the device by first attaching the upper jaw and the lower jaw of the alignment head to an area on the pressure mechanism between the mechanism and the alignment head. The means of removable attachment include but are not limited to a hinge, a snap-fit bolt and lock, a screw-in bolt and lock, a sliding bolt and lock, and combinations thereof. After the alignment head has been securely attached to the pressure mechanism, the device is ready to use for aligning pipe elements as described in the aforementioned example.

Alternatively, the area for removable attachment of the alignment head may exist between the pressure mechanism and the handle. The pressure mechanism is typically integrally attached to the alignment head under this example but necessarily so. Thus, the alignment head having the pressure mechanism integrally attached to the head can be removably attached to the handle. The means of removable attachment include but are not limited to a hinge, a snap-fit bolt and lock, a screw-in bolt and lock, a sliding bolt and lock, and combinations thereof.

In this example the pressure mechanism is a torsion spring mechanism, and the pipe elements are straight pipes. The jaws and are opened to provide a clearance wide enough for the straight pipes to be inserted or slipped into the jaws. Anytime during the insertion step, the alignment elements can be adjusted, using the alignment element rod, also to allow maximum clearance for insertion of the straight pipes.

The straight pipes then are inserted until the ends of the pipes are in the vicinity of each other and can be viewed in the tack weld window. Pressure is applied to the pipes via the pressure mechanism to loosely secure the pipes within the jaws, and more specifically via the alignment element bodies of the alignment elements. The alignment element rods are then adjusted to further apply pressure to the pipes; to secure the pipes within the alignment head; and to axially align the pipes.

The method of applying pressure, securing, and axially aligning the straight pipes is an iterative one. The method is repeated as many times as necessary to accurately and precisely align the pipes with each other for tack welding and other welding tasks. Furthermore, applying pressure, securing, and axially aligning the pipes can be done in any order or in any combination. For example, a user can first secure the pipes using the alignment elements before using the pressure mechanism to lock the pipe elements in place.

Having accurately and precisely aligned the straight pipes, the tack weld gap typically then is set using the tack weld gap shim. The tack weld shim end of the tack shim is inserted between the straight pipes via the adjustment head. In this example, the tack shim comprises a threaded shaft and a conical end that is demarcated. The head is turned or rotated in a clockwise direction causing the shim and more specifically the conical end to move towards/into the tack weld gap. In this example, each demarcation is equivalent to 4 mm of space between the pipe elements. Inserting the shim end of the tack shim to the 4^{th} demarcation is equivalent to setting the tack weld gap to 16 mm.

Alternatively, each demarcation could be equivalent to 1 mm, 2 mm, 3 mm or any unit of distance typically used for tack weld gaps and tack welding conditions. The tack weld gap can be set from about ⅛ inch to about ½ inch. After having set the tack weld gap, the user then may tack weld the pipe elements knowing that the straight pipes have been accurately and precisely aligned and the tack weld gap set per the user's requirement. The device containing the pipes, axially aligned and having a chosen tack weld gap, is held in one hand while the other hand is used to hold and operate a welding torch for subsequent tack welding.

After tack welding is completed, the user removes the tack weld shims from the tack weld gap. The configuration of the shim end is conducive for easy removal. The straight pipes exert significant pressure on the shim end due to cooling of the tack weld and a resultant contraction of the tack weld. The conical shape of the shim end allows the user to easily remove the tack weld shim from the shim gap. Any tack weld shim end having concial, cylindrical, trapezoidal, frustro-conical, and combinations thereof or having coatings with materials including but not limited to ceramics, nano-composites, polymer composites, nano-polymer composites, alloys of the aforementioned can be used thereof in accordance with the device and method of the present invention. The user then may disassemble the device by removing the alignment head from the area on the pressure mechanism in which the alignment head was attached.

Alternatively, a user may axially align and tack weld elements using an aligning device 1 having non-integrally attached alignment elements 60, i.e., reversibly attachable alignment elements 60 for securing and axially aligning pipe elements. Referring to FIGS. 1-5, in use of the device 1 in accordance with the present invention, a user attaches the reversibly attachable alignment elements 60 to the alignment head 20 of the device 1. The alignment elements 60 may be secured to the alignment head 20 via a wing nut, a square nut, flanges, clips, and the like.

The user then adjusts the device 1 with the alignment elements 60 attached to the alignment head 20 to an open configuration (see FIG. 2B) by releasing the pressure mechanism 70. In this example the pressure mechanism 70 is a torsion spring mechanism, and the pipe elements 36 and 37 are straight pipes.

The jaws 21 and 22 are opened to provide a clearance wide enough for the straight pipes 36 and 37 to be inserted or slipped into the jaws 21 and 22 along the directional arrows 30 and 31 respectively or along the directional arrow 33. Anytime during the insertion step, the alignment elements 60 can be adjusted, using the alignment element rod 64, also to allow maximum clearance for insertion of the straight pipes 36 and 37.

The straight pipes 36 and 37 then are inserted until the edges of the pipes 36 and 37 are in the vicinity of each other and can be viewed in the tack weld window 33. Pressure is applied to the pipes 36 and 37 via the pressure mechanism 70 to loosely secure the pipes 36 and 37 within the jaws 21 and 22, and more specifically via the alignment element bodies 66 of the alignment elements 60. The alignment element rods 64 are then adjusted to further apply pressure to the pipes 36 and 37; to secure the pipes 36 and 37 within the alignment head 20; and to axially align the pipes 36 and 37.

The method of applying pressure, securing, and axially aligning the straight pipes 36 and 37 is an iterative one. The method is repeated as many times as necessary to accurately and precisely align the pipes 36 and 37 with each other for tack welding and other welding tasks. Furthermore, applying pressure, securing, and axially aligning the pipes 36 and 37 can be done in any order or in any combination. For example, a user can first secure the pipes 36 and 37 using the alignment elements 60 before using the pressure mechanism 70 to lock the pipe elements 36 and 37 in place.

Having accurately and precisely aligned the straight pipes 36 and 37, the tack weld gap 38 typically then is set using the tack weld gap shim 105. The tack weld shim end 106 of the tack shim 105 is inserted between the straight pipes 36 and 37 via the adjustment head 108. In this example, the tack shim 106 comprises a threaded shaft 107 and a conical end 106 that is demarcated. The head 108 is turned or rotated in a clockwise direction causing the shim 105 and more specifically the conical end 106 to move towards/into the tack weld gap 38. In this example, each demarcation is equivalent to 4 mm of space between the pipe elements 36 and 37. Inserting the end 106 of the tack shim 105 to the 4^{th} demarcation is equivalent to setting the tack weld gap 38 to 16 mm.

Alternatively, each demarcation could be equivalent to 1 mm, 2 mm, 3 mm or any unit of distance typically used for tack weld gaps 38 and tack welding conditions. The tack weld gap 38 can be set from about ⅛ inch to about ½ inch. After having set the tack weld gap 38, the user then may tack weld the pipe elements 36 and 37 knowing that the straight pipes 36 and 37 have been accurately and precisely aligned and the tack weld gap 38 set per the user's requirement. The device 1 containing the pipes 36 and 37, axially aligned and having a chosen tack weld gap 38, is held in one hand while the other hand is used to hold and operate a welding torch for subsequent tack welding.

After tack welding is completed, the user removes the tack weld shims 105 from the tack weld gap 38. The configuration of the shim end 106 is conducive for easy removal. The straight pipes 36 and 37 exert significant pressure on the shim end 106 due to cooling of the tack weld and a resultant contraction of the tack weld. The conical shape of the shim end 106 allows the user to easily remove the tack weld shim 105 from the shim gap 38. Any tack weld shim 105 having concial, cylindrical, trapezoidal, frustro-conical, and combinations thereof or having coatings with materials including but not limited to ceramics, nano-composites, polymer composites, nano-polymer composites, alloys of the aforementioned can be used thereof in accordance with the device and method of the present invention. The user then may disassemble the device 1 by removing the alignment elements 60 from the alignment head 20.

Alternatively, a user may tack weld elements using an aligning device 1 without axially aligning the elements to be tack welded together. The device 1 can be used with or without the alignment elements 60 to receive and secure the elements to be tack welded. Typically, the configuration of the device 1, without alignment elements, is used to tack weld elements such as railings, tubes, and structural shapes.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. An aligning device comprising:
a head configured to receive a first element and a second element; and
at least one alignment element wherein said alignment element axially aligns said first element with said second element.

2. The device of claim 1, wherein further comprising a pressure mechanism for applying a selectable pressure to said first element and to said second element, wherein said pressure mechanism is operatively connected to said head.

3. The device of claim 2, wherein the pressure mechanism includes a ratchet and pawl mechanism.

4. The device of claim 2, wherein the selectable pressure is in a range from about 0 Pounds per Square Inch (PSI) to about 2,500 PSI.

5. The device of claim 1, wherein said first element is selected from a group consisting of a 90° elbow, a 45° elbow, a tee, a reducer, a flange, a straight pipe, a tube, a hand-railing, a boiler tube, a square tube, a bar, a structural shape, and combinations thereof.

6. The device of claim 1, wherein said second pipe element is selected from a group consisting of a 90° elbow, a 45° elbow, a tee, a reducer, a flange, a straight pipe, a tube, a hand-railing, a boiler tube, a square tube, a bar, a structural shape, and combinations thereof.

7. The device of claim 1, wherein said at least one alignment element is removably attached to said head.

8. The device of claim 1, further comprising a plurality of tack weld gap elements configured to operatively attach to said head.

9. The device of claim 8, wherein said plurality of tack weld gap elements provide a selectable tack weld gap between said first element and said second element.

10. The device of claim 9, wherein said selectable tack weld gap is in a range from about ⅛ inch to about ½ inch.

11. The device of claim 1, further wherein said first element is a first pipe and said second element is a second pipe; and further comprising:
at least one tack weld element wherein said tack weld element provides a selectable tack weld gap between said first pipe and to said second pipe; and
a pressure mechanism operatively attached to said head for providing a selectable pressure to said first pipe and said second pipe.

12. The device of claim 1, further comprising a handle attached to said head.

13. The device of claim 12, further comprising:
a plurality of tack weld gap elements wherein said tack weld gap elements provide a tack weld gap between said first element and said second element; and further wherein said head is removably attachable to said handle;.

14. An aligning device comprising:
a handle;
a head configured to receive a first element and a second element, wherein said head is configured to be removably attachable to a handle; and
at least one alignment element wherein said alignment element axially aligns said first element with said second element.

15. The device of claim 14, wherein said head is operative attached to a pressure mechanism, said pressure mechanism being for applying a selectable pressure to said first element and said second element.

16. The device of claim 15, wherein said pressure mechanism is a ratchet and pawl mechanism.

17. The device of claim 15, wherein the selectable pressure is in a range from about 0 Pounds per Square Inch (PSI) to about 2,500 PSI.

18. The device of claim 14, wherein said first element is selected from a group consisting of a 90° elbow, a 45° elbow, a tee, a reducer, a flange, a straight pipe, a tube, a hand-railing, a boiler tube, a square tube, a bar, a structural shape, and combinations thereof.

19. The device of claim 14, wherein said second element is selected from a group consisting of a 90° elbow, a 45° elbow, a tee, a reducer, a flange, a straight pipe, a tube, a hand-railing, a boiler tube, a square tube, a bar, a structural shape, and combinations thereof.

20. The device of claim 14, wherein said at least one alignment element is removably attached to said head.

21. The device of claim 14, further comprising a plurality of tack weld gap elements configured to operatively attach to said head.

22. The device of claim 21, wherein said plurality of tack weld gap elements provide a selectable tack weld gap between said first element and said second element.

23. The device of claim 22, wherein said selectable tack weld gap is in a range from about ⅛ inch to about ½ inch.

24. The device of claim 14, further comprising said handle.

25. The device of claim 24, wherein said first element is a first pipe and said second element is a second pipe; and further comprising:
a plurality of tack weld gap shims for setting a tack weld gap between said first pipe and said second pipe.

26. An aligning device comprising:
a head configured to receive a first element and a second element, wherein said head is configured to be removably attachable to a handle.

27. The device of claim 26, further wherein said head is configured to do one selected from the group of fully surround, substantially surround, partially surround, fully encircle, substantially encircle, partially encircle, fully confine, substantially confine, partially confine, fully envelope, substantially envelope, partially envelope, and combinations thereof.

28. The device of claim 26, wherein said first element is selected from a group consisting of a 90° elbow, a 45° elbow, a tee, a reducer, a flange, a straight pipe, a tube, a hand-railing, a boiler tube, a square tube, a bar, a structural shape, and combinations thereof.

29. The device of claim 26, wherein said second element is selected from a group consisting of a 90° elbow, a 45° elbow, a tee, a reducer, a flange, a straight pipe, a tube, a hand-railing, a boiler tube, a square tube, a bar, a structural shape, and combinations thereof.

30. The device of claim 26, further comprising at least one alignment element for axially aligning said first element with said second element.

31. The device of claim 30, wherein said at least one alignment element is removably attachable to said head.

32. The device of claim 26, further comprising a plurality of tack weld gap elements removably attachable to said head.

33. The device of claim 32, wherein said plurality of tack weld gap elements provide a selectable tack weld gap between said first element and said second element.

34. The device of claim 26, further comprising said handle.

35. The device of claim 26, further comprising a pressure mechanism removably attachable to said head.

36. The device of claim 26, wherein said first element is a first pipe and said second element is a second pipe; and further comprising:
at least one alignment element wherein said alignment element axially aligns said first pipe with said second pipe; and
at least one tack weld gap shim for providing a selectable tack weld gap.

37. The device of claim 26, wherein said first element is a first pipe and said second element is a second pipe; and further comprising:
a plurality of tack weld gap elements wherein said tack weld gap elements are configured to set a tack weld gap between said first pipe with said second pipe; and
a handle, wherein said head is attached to said handle.

38. An aligning device comprising:
an alignment element removably attachable to an alignment head, wherein said alignment head is configured to receive a first element and a second element.

39. The device of claim 38, wherein said alignment element further comprises an alignment adjustment rod and a contact area.

40. The device of claim 39, wherein said contact area is a distinguishable extent of a surface of said alignment element that comes in contact with said first element or said second element.

41. The device of claim 40, wherein a composition of said surface is selected from a group consisting of teeth, pads, irregular projections, regular projections, grooved recesses, micro-teeth, micro-pads, mico-projections, nano-coatings, and combinations thereof.

42. The device of claim 38, wherein said first element is selected from a group consisting of a 90° elbow, a 45° elbow, a tee, a reducer, a flange, a straight pipe, a tube, a hand-railing, a boiler tube, a square tube, a bar, a structural shape, and combinations thereof.

43. The device of claim 38, wherein said second element is selected from a group consisting of a 90° elbows, a 45° elbow, a tee, a reducer, a flange, a straight pipe, a tube, a hand-railing, a boiler tube, a square tube, a bar, a structural shape, and combinations thereof.

44. The device of claim 38, wherein said first element is a first pipe and said second element is a second pipe.

45. An aligning method comprising:
providing a first element and a second element;
providing a head configured to receive said first element and said second element, wherein said head includes a least one alignment element further wherein said alignment element is for axially aligning said first element with said second element; and
axially aligning said first element with said second element.

46. The method of claim 45, further comprising:
applying a selectable pressure to said first element and said second element.

47. The method of claim 45, wherein said first element is selected from a group consisting of a 90° elbow, a 45° elbow, a tee, a reducer, a flange, a straight pipe, a tube, a hand-railing, a boiler tube, a square tube, a bar, a structural shape, and combinations thereof.

48. The method of claim 45, wherein said second element is selected from a group consisting of a 90° elbow, a 45° elbow, a tee, a reducer, a flange, a straight pipe, a tube, a hand-railing, a boiler tube, a square tube, a bar, a structural shape, and combinations thereof.

49. The method of claim 45, wherein said alignment head is removably attachable to a handle.

50. The method of claim 45, wherein said alignment head is removably attachable to a pressure mechanism.

51. The method of claim 45, wherein said first element is a first pipe and said second element is a second pipe.

52. An aligning method comprising:
providing a first element and a second element;
providing a head configured to receive said first element and said second element;
attaching to said head a plurality of tack weld gap elements configured to set a tack weld gap between said first element and said second element; and
setting said tack weld gap between said first element and said second element.

53. The method of claim 52, further comprising:
providing a pressure mechanism for applying a selectable pressure to said first element and said second element, wherein said pressure mechanism is operatively connected to said head.

54. The method of claim 52, wherein said first element is selected from a group consisting of a 90° elbow, a 45° elbow, a tee, a reducer, a flange, a straight pipe, a tube, a hand-railing, a boiler tube, a square tube, a bar, a structural shape, and combinations thereof.

55. The method of claim 52, wherein said second element is selected from a group consisting of a 90° elbow, a 45° elbow, a tee, a reducer, a flange, a straight pipe, a tube, a hand-railing, a boiler tube, a square tube, a bar, a structural shape, and combinations thereof.

56. The method of claim 52, further comprising:
providing a handle operatively connected to said head.

57. The method of claim 52, wherein said first element is a first pipe and said second element is a second pipe.

58. An aligning method comprising:
providing a first element and a second element;
providing a removably attachable alignment element configured to fit an alignment head, wherein said alignment head is configured to receive and fit said first element and said second element; and
axially aligning said first element with said second element.

59. The method of claim 58, wherein said alignment element further comprises an alignment adjustment rod and a contact area.

60. The method of claim 59, wherein said contact area is a distinguishable extent of a surface of said alignment element that comes in contact with said first element or said second element.

61. The device of claim 60, wherein a composition of said surface is selected from a group consisting of teeth, pads, irregular projections, regular projections, grooved recesses, micro-teeth, micro-pads, mico-projections, nano-coatings, and combinations thereof.

62. The method of claim 58, wherein said first element is selected from a group consisting of a 90° elbow, a 45° elbow, a tee, a reducer, a flange, a straight pipe, a tube, a hand-railing, a boiler tube, a square tube, a bar, a structural shape, and combinations thereof.

63. The method of claim 58, wherein said second element is selected from a group consisting of a 90° elbow, a 45° elbow, a tee, a reducer, a flange, a straight pipe, a tube, a hand-railing, a boiler tube, a square tube, a bar, a structural shape, and combinations thereof.

64. The method of claim 58, wherein said first element is a first pipe and said second element is a second pipe.
